(19) United States
(12) Patent Application Publication
(10) Pub. No.: US 2010/0065293 A1
(43) Pub. Date: Mar. 18, 2010

(54) METHOD FOR OPERATING AN ELECTRICAL POWER TOOL, AND A DRIVE UNIT FOR AN ELECTRIC POWER TOOL

(76) Inventor: Guenter LOHR, Leinfelden-Echterdingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/497,104

(22) Filed: Jul. 2, 2009

(30) Foreign Application Priority Data
Jul. 2, 2008 (DE) 10 2008 040 096.3

(51) Int. Cl. B25B 23/147; B23Q 5/18; B25B 21/00

(52) U.S. Cl. 173/1; 173/176; 173/217

(57) ABSTRACT

The invention relates to a method for operating a handheld electric power tool, having an electric motor that is drivable at a rated torque as the maximum allowable motor torque by the application of a maximum allowable motor current. The method includes the steps of manually furnishing a specification of a maximum torque, in which the maximum torque is within a setting range between a minimum set torque and the rated torque, operating the electric motor by applying a motor voltage which corresponds to an rpm desired by the user, and limiting the motor current to a current value that depends on the furnished specification of the maximum torque.

The invention also related to a drive unit for an electric power tool, which includes an electric motor drivable at a rated torque as a maximum allowable motor torque by application of a maximum allowable motor current. A setting element manually furnishes a specification of a maximum torque, the maximum torque being within a range between zero and the rated torque. A triggering unit operates the electric motor by applying a motor voltage that corresponds to an rpm desired by the user. A motor controller limits the motor current to a current value that depends on the furnished specification of the maximum torque.

### CROSS-REFERENCE TO RELATED APPLICATION

This application is based on German Patent Application 10 2008 040 096.3 filed Jul. 2, 2008.

### BACKGROUND OF THE INVENTION

1. Field of the Invention

The invention relates to a method for operating a handheld electric power tool, having a drive unit. The invention also relates to a drive unit for an electric power tool having a torque limiter.

2. Description of the Prior Art

In electric power tools that have a drive unit, it is often necessary for the torque that is output, such as the spindle torque output via a spindle, to be limited in every state of operation. To that end, a torque monitor and a torque limiter are as a rule provided.

In an electrically operated power tool, such as a cordless screwdriver, such torque monitoring and torque limitation can be attained by providing that the current which is applied to a drive unit is switched off as soon as the motor current exceeds a previously fixed current threshold.

In a permanently excited electric direct current motor, the motor torque is approximately proportional to a motor current that flows through the electric motor. As a result, it is possible in principle for the torque output by the electric motor to be adjusted by specifying the current in a setting range.

However, upon changes in rpm of the drive unit of the power tool, it can happen that the motor torque and the torque output to the applicable tool differ. This is a consequence of the fact that the spindle torque is the result of the difference between the motor torque, on the one hand, and the moment of acceleration of the rotating masses of the electric motor and of the gear of the drive unit, on the other. Hence the motor current can exceed the previously fixed current threshold in an acceleration event, even though the spindle torque required is less and may even be below the torque defined by the fixed current threshold.

Moreover, in very cold ambient temperatures, increased friction can occur at a bearing of the electric motor and/or the revolving tool holding fixture, and this friction can also contribute to tripping the limitation of the motor torque earlier than intended, because of the thus-elevated motor current.

To reduce the risk of unintended tripping, an electric or electronic motor shutoff is often deactivated in response to an elevated torque during a starting phase of the electric motor, so that the current supply to the electric motor, at least in this starting phase, cannot be automatically interrupted. Although this does prevent the power tool from being switched off unintentionally by the electric or electronic motor torque monitor, nevertheless, particularly on resumption of operation of the electric power tool, for instance when a screw that had previously been screwed in only partway, is immediately screwed in further, an elevated torque can occur with which to accomplish the further screwing.

It is also prior art to limit the setting range to a range for the least settable torque to from 50% to 70% of the maximum torque.

It is also known, for instance in the cordless screwdriver, to limit a torque for screwing in a workpiece by means of a mechanical overload coupling between a tool holding fixture and an electric motor. However, in an overload situation such mechanical overload couplings often involve intensive noise, and they are moreover usually relatively expensive to make.

### OBJECT AND SUMMARY OF THE INVENTION

It is the object of the present invention to furnish a method for operating an electric power tool as well as a drive unit for an electric power tool, in which on the one hand, shutoff of the drive unit because of an overload protection is avoided upon startup or switching on of the electric power tool because of moments of inertia, and it is furthermore assured that during a startup or switching-on phase, an overly high torque is not transmitted to the tool.

In a first aspect, a method for operating a handheld electric power tool, having an electric motor that is drivable at a rated torque as the maximum allowable motor torque by the application of a maximum allowable motor current is provided.

The method includes the following steps:
manually furnishing a specification of a maximum torque, in which the maximum torque is within a setting range between a minimum set torque and the rated torque;
operating the electric motor by applying a motor voltage which corresponds to an rpm desired by the user; and
limiting the motor current to a current value that depends on the furnished specification of the maximum torque.

The above method in a simple way avoids a torque, output by the electric power tool during operation of the electric power tool or in a startup phase, from exceeding a desired maximum torque by providing that the motor current to the electric motor is limited such that it never exceeds a motor current determined by the specification of the maximum torque. If a motor voltage is applied that would lead to a higher motor current, then this voltage is for instance limited to the value of the motor current determined by the specification of the maximum torque. Shutoff upon attaining this motor current is as a rule also avoided. The motor voltage is adjusted in the range of the limitation such that the motor maintains the previously defined value. In this way, it is attained that the power tool constantly furnishes the desired torque.

In one embodiment, the specification of the maximum torque can be set by adjusting a manually operable setting element.

The minimum set torque can be set to a value of zero or a value between zero and 50%, preferably 30%, and especially preferably 20% of the rated torque.

The specification of the maximum torque can also correspond to a specification of the maximum motor current.

In one embodiment, while the motor current is being limited to the current value, the rpm of the electric motor can be ascertained, and as a function of the ascertained rpm of the electric motor, the motor current is shut off.

The motor current can also be shut off if the rpm is zero. In particular, the motor current can be shut off after a specified length of time has elapsed after the time at which the rpm has reached zero. In this way, the tool holding fixture furnishes the predetermined torque for a defined length of time after the stoppage of the tool holding fixture. The shutoff has the advantage that electrical energy can be saved. This is particularly appropriate when batteries as current sources.

In one embodiment, shutoff of the electric motor because of exceeding of a current threshold value by the motor current can be avoided.

As the lower limit for the setting range for the specification of the maximum torque, a specification of a torque can be assumed that corresponds to a motor current at which a runaway of the electric motor is possible.

In a further aspect, a drive unit for an electric power tool is provided. The drive unit includes:
an electric motor that is drivable at a rated torque as a maximum allowable motor torque by application of a maximum allowable motor current;
a setting element for manually furnishing a specification of a maximum torque, the maximum torque being within a range between a minimum set torque and the rated torque;
a triggering unit for operating the electric motor by applying a motor voltage that corresponds to an rpm desired by the user; and
a motor controller for limiting the motor current to a current value that depends on the furnished specification of the maximum torque.

A hand control element can also be provided, for setting or adjusting the motor voltage that corresponds to an rpm desired by the user.

In one embodiment, the setting element can include the hand control element and an input unit, and the motor controller is coupled with the hand control element and the input unit in such a way that depending on an actuation of the input unit, either the default specification of the maximum torque, or the default rpm of the electric motor, can be manually specified.

In one embodiment, a battery with one or more rechargeable or nonrechargeable cells can be provided as a current source for operating the electric motor.

In particular, the setting element can be embodied for specifying a default amplification factor for an amplifier with variable amplification, and the amplifier amplifies a specification about a motor current and furnishes a specification, multiplied by the factor, to the motor controller, the motor controller being embodied for limiting the motor current in accordance with the multiplied specification about the motor current.

In a further aspect, an electric power tool having the aforementioned a drive unit and a tool holding fixture is provided, in which the tool holding fixture and the electric motor of the drive unit are coupled to one another directly or via a gear.

### BRIEF DESCRIPTION OF THE DRAWINGS

The invention will be better understood and further objects and advantages thereof will become more apparent from the ensuing detailed description of preferred embodiments taken in conjunction with the drawings, in which:

FIG. 1 schematically shows a view of a cordless screwdriver having an electric motor; and

FIG. 2 schematically shows a circuit diagram for switching the electric motor of the cordless screwdriver of FIG. 1.

### DESCRIPTION OF THE PREFERRED EMBODIMENTS

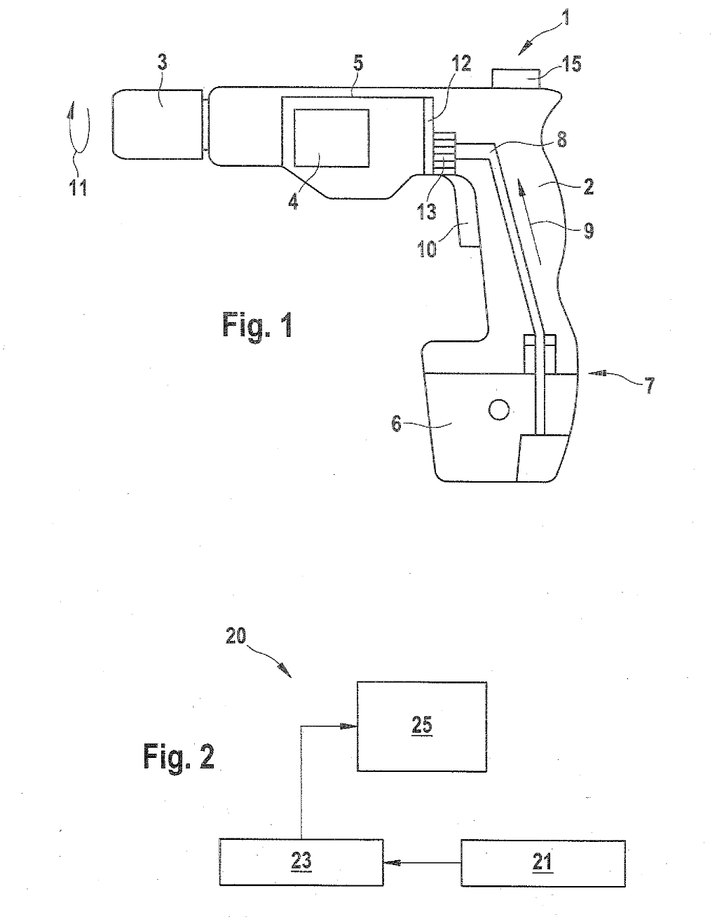

In FIG. 1, a power tool 1 is shown, which has a housing 2 in which a drive device 5 is disposed. The drive device 5 is coupled with a tool holding fixture 3 directly or via a gear (not shown), so that the tool holding fixture 3 is driven by the drive device 5. The coupling between the tool holding fixture 3 and the drive device S is rigid, and no mechanical devices are provided for undoing the rigid connection, for instance for torque limitation.

For furnishing a driving torque, an electric motor 4 is provided in the drive device 5 and is triggerable with a suitable motor current via a triggering device 12 for furnishing a motor torque. The triggering unit 12 is connected to a motor controller 13 that is coupled to a hand control element 10 such as a trigger type element, so that a user, by actuating the hand control element 10 and by specifying a default motor voltage, can manually adjust the rpm to be adjusted by the power tool 1. The motor controller 13, via the triggering unit 12, preferably triggers the electric motor 4 with a pulse width modulated (PWM) signal, so that the triggering unit 12 furnishes a voltage to the electric motor 4 that is equivalent to the product of the pulse duty factor of the PWM signal and the furnished supply voltage.

A setting element 15 is also provided, with which a maximum torque, which is output by the power tool 1 to the tool holding fixture 3, can be adjusted. The maximum torque is determined as the maximum motor current by the motor controller 13 as a function of an adjustment of the setting element 15. If the current value fixed by the setting element 15 is exceeded, the motor controller 13 reduces the voltage furnished to the electric motor 4. By way of example, the setting element 15 may be provided as a rotary potentiometer.

A current source 6 is also provided, in the form of a battery or a rechargeable battery, which supplies the drive device 5 with the supply voltage or with electrical energy. The current source 6 is removably attached to a bottom end 7 of the housing 2. In the motor controller 13, as a function of the actuation or position of the hand control element 10, one or more control signals are furnished to the triggering unit 12, in order to supply the electric motor 4 of the drive device 5 with a defined motor voltage in a suitable way. The application of the motor voltage to the electric motor 4 causes a corresponding motor current to flow.

The motor controller 13 acts as a motor current limiter for the electric motor 4 of the drive device 5. The motor current limitation functions such that the motor current flowing into the electric motor 4 is limited to a motor current that corresponds to a current at which the torque, set by the setting element 15, is reached and maintained. On reaching the maximum torque specified by the setting element 15, the electric motor 4 is not shut off; instead, it maintains the applied torque until the user of the power tool 1, with the aid of the hand control element 10, switches the power tool 1 off, for instance by letting go of the hand control element 10. On reaching the maximum torque, the rpm can drop as a function of the loading torque, and—depending on the load situation—it can even drop to a point of blocking.

It may be provided that if the motor controller 13 ascertains a complete blocking of the tool holding fixture or of the electric motor 4 (the electric motor 4 is no longer rotating), the preset motor current for limiting the torque is still maintained for a certain length of time, until the motor controller 13 switches off the motor current, regardless of the default specification by the user of the power tool 1, or in other words regardless of the state of actuation of the hand control element 10.

In principle, the motor current or motor torque can be set to a value in the range from a minimum set torque corresponding to the motor current, such as zero, up to a maximum rated current or a maximum rated torque, which can be fixedly specified. However, to assure a startup of the electric motor 4, it may be necessary to select the motor current such that the idling current and the additional current component by which an additional motor torque can be furnished, can be overcome with the internal moments of friction or adhesion of the entire arrangement. For instance, it may be provided that the motor current be defined with the aid of the setting element 15 to a setting range of 20% (corresponding to the minimum set torque) up to 100% of the rated motor current of the electric motor 4, or in other words the motor current at a rated torque.

In FIG. 2, a block circuit diagram is shown for illustrating the function for limiting the motor current of the electric motor 4. Reference numeral 21 in the block circuit diagram indicates a current measuring device with which the motor current into the electric motor 4 is ascertained. For example, the current measuring device 21 is a current detector, such as a shunt resistor, connected in series with the electric motor 4, at which a measurement voltage can be picked up that varies in proportion to the motor current. The current measuring device 21, as a specification about the motor current, furnishes the measurement voltage.

The specification about the motor current is delivered to an amplifier 23 that has variable amplification. The variable amplification can be adjusted in the amplifier 23, for instance via the setting element 15, which may for instance be embodied as a potentiometer, so that the specification about the motor current is multiplied by a factor that is specified by the potentiometer.

The specification, multiplied by the factor, about the motor current is now delivered to the triggering unit 25, which adjusts the current through the electric motor 4. The factor corresponds to the inverse of the proportion to which the motor current, or the motor torque corresponding to the motor current, is to be limited relative to the rated motor current or rated torque.

The variable amplification can furthermore be done automatically as a function of rpm, for instance such that at a low rpm specified by the user, a low torque is produced.

The setting element 15 and the hand control element 10 may also be embodied as a common hand control element, with which first the specification about the maximum torque can be adjusted, and then the rpm can be adjusted by default specification by the user, as long as the set maximum torque has not yet been reached. To that end, an input unit (not shown), such as a switchover device or confirmation button may be provided, with which the specification about the maximum torque can be confirmed to the motor controller 13. After confirmation by the input unit, the hand control element is used as described above for manually specifying the default rpm.

The foregoing relates to preferred exemplary embodiments of the invention, it being understood that other variants and embodiments thereof are possible within the spirit and scope of the invention, the latter being defined by the appended claims.

I claim:

1. A method for operating a handheld electric power tool, having an electric motor drivable at a rated torque as the maximum allowable motor torque by the application of a maximum allowable motor current, comprising the steps of:
manually furnishing a specification of a maximum torque, in which the maximum torque is within a setting range between a minimum set torque and the rated torque;
operating the electric motor by applying a motor voltage which corresponds to an rpm desired by the user; and
limiting the motor current to a current value that depends on the furnished specification of the maximum torque.

2. The method as defined by claim 1, wherein the specification of a maximum torque is set by adjusting a manually operable setting element.

3. The method as defined by claim 1, wherein the minimum set torque is set to a value between 0 and 30% of the rated torque.

4. The method as defined by claim 1, wherein the specification of the maximum torque corresponds to a specification of the maximum motor current.

5. The method as defined by claim 1, wherein while the motor current is limited to the current value, the rpm of the electric motor is ascertained, and as a function of the ascertained rpm of the electric motor, the motor current is switched off.

6. The method as defined by claim 5, wherein the motor current is switched off when the rpm is zero.

7. The method as defined by claim 5, wherein the motor current is switched off after a predetermined length of time has elapsed after the time at which the rpm has reached zero.

8. The method as defined by claim 1, wherein a shutoff of the electric motor is avoided
by means of an exceeding of a current threshold value by the motor current.

9. The method as defined by claim 1, wherein the setting range for the specification of the maximum torque has a lower torque limit, which corresponds to a maximum motor current at which a runaway of the electric motor (4) is possible.

10. A drive unit for an electric power tool, comprising:
an electric motor drivable at a rated torque as a maximum allowable motor torque by application of a maximum allowable motor current;
a setting element which manually furnishes a specification of a maximum torque, the maximum torque being within a range between zero and the rated torque;
a triggering unit which operates the electric motor by applying a motor voltage that corresponds to an rpm desired by the user; and
a motor controller which limits the motor current to a current value that depends on the furnished specification of the maximum torque.

11. The drive unit as defined by claim 10, further comprising a hand control element which adjusts the motor voltage that corresponds to an rpm desired by the user.

12. The drive unit as defined by claim 11, wherein the setting element includes the hand control element and an input unit, and the motor controller is coupled with the hand control element in such a way that depending on an actuation of the input unit, either the specification of the maximum torque, or the rpm of the electric motor, can be manually predetermined.

13. The drive unit as defined by claim 10, wherein a battery with one or more rechargeable or nonrechargeable cells is provided as a current source for operating the electric motor.

14. The drive unit as defined by claim 11, wherein a battery with one or more rechargeable or nonrechargeable cells is provided as a current source for operating the electric motor.

15. The drive unit as defined by claim 12, wherein a battery with one or more rechargeable or nonrechargeable cells is provided as a current source for operating the electric motor.

16. The drive unit as defined by claim 10, wherein the setting element is embodied to specify an amplification factor for an amplifier with variable amplification, and the amplifier amplifies a specification about a motor current and furnishes a specification, multiplied by the factor, to the motor controller, the motor controller being embodied to limit the motor current in accordance with the multiplied specification about the motor current.

17. The drive unit as defined by claim 11, wherein the setting element is embodied to specify an amplification factor for an amplifier with variable amplification, and the amplifier amplifies a specification about a motor current and furnishes a specification, multiplied by the factor, to the motor controller, the motor controller being embodied to limit the motor current in accordance with the multiplied specification about the motor current.

18. The drive unit as defined by claim 12, wherein the setting element is embodied to specify an amplification factor for an amplifier with variable amplification, and the amplifier amplifies a specification about a motor current and furnishes a specification, multiplied by the factor, to the motor controller, the motor controller being embodied to limit the motor current in accordance with the multiplied specification about the motor current.

19. The drive unit as defined by claim 10, further comprising a tool holding fixture, wherein the tool holding fixture and the electric motor of the drive unit are coupled to one another directly or via a gear.

20. The drive unit as defined by claim 18, further comprising a tool holding fixture, wherein the tool holding fixture and the electric motor of the drive unit are coupled to one another directly or via a gear.
